(19) United States
(12) Patent Application Publication
(10) Pub. No.: US 2024/0107374 A1
(43) Pub. Date: Mar. 28, 2024

(54) METHOD AND APPARATUS FOR CHANNEL INFORMATION TRANSFER USING NEURAL NETWORK IN COMMUNICATION SYSTEM

(71) Applicant: ELECTRONICS AND TELECOMMUNICATIONS RESEARCH INSTITUTE, Daejeon (KR)

(72) Inventors: Yong Jin KWON, Daejeon (KR); Han Jun PARK, Daejeon (KR); An Seok LEE, Daejeon (KR); Heesoo LEE, Daejeon (KR); Yun Joo KIM, Daejeon (KR); Hyun Seo PARK, Daejeon (KR); Jung Bo SON, Daejeon (KR); Yu Ro LEE, Daejeon (KR)

(73) Assignee: ELECTRONICS AND TELECOMMUNICATIONS RESEARCH INSTITUTE, Daejeon (KR)

(21) Appl. No.: 18/472,394

(22) Filed: Sep. 22, 2023

(30) Foreign Application Priority Data
Sep. 22, 2022 (KR) 10-2022-0120252
Aug. 31, 2023 (KR) 10-2023-0115725

(51) Int. Cl. H04W 28/06

(52) U.S. Cl. CPC H04W 28/06

(57) ABSTRACT

A method of a terminal may comprise: receiving a reference signal from a base station; generating channel information based on the reference signal; generating wavelet-transformed channel information by applying wavelet transform to the channel information; generating compressed channel information by compressing the wavelet-transformed channel information; and transmitting the compressed channel information to the base station.

### CROSS-REFERENCE TO RELATED APPLICATIONS

This application claims priority to Korean Patent Applications No. 10-2022-0120252, filed on Sep. 22, 2022, and No. 10-2023-0115725, filed on Aug. 31, 2023, with the Korean Intellectual Property Office (KIPO), the entire contents of which are hereby incorporated by reference.

### BACKGROUND

### 1. Technical Field

Exemplary embodiments of the present disclosure relate to a technique for channel information transfer using a neural network in a communication system, and more specifically, to a channel information transfer technique using a neural network in a communication system in which channel information can be transferred using Wavelet transform.

### 2. Related Art

With the development of information and communication technology, various wireless communication technologies have been developed. Typical wireless communication technologies include long term evolution (LTE), new radio (NR), 6th generation (6G) communication, and/or the like. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, the 3 rd generation partnership project (3GPP) release 18 is discussing technologies for improving a radio environment by utilizing machine learning techniques. In particular, the 3GPP release 18 is discussing methods of transferring direction channel information or information related to the channel information through compression using machine learning techniques. The information compressed in the above-described methods may be decompressed. A neural network model used for intelligent compression and decompression of the channel information may directly use the channel information or data of characteristics extracted from the channel information as input data for compression. The data obtained by extracting characteristics from the channel information may be representatively an eigenvector of the channel information. Since the channel information such as the eigenvector is relatively out of continuity with surrounding data, methods for supplementing this may be required.

### SUMMARY

Exemplary embodiments of the present disclosure are directed to providing a method and an apparatus for channel information transfer using a neural network in a communication system in which channel information is transferred using Wavelet transform in consideration of a change in channel characteristics.

According to a first exemplary embodiment of the present disclosure, a method of a terminal may comprise: receiving a reference signal from a base station; generating channel information based on the reference signal; generating wavelet-transformed channel information by applying wavelet transform to the channel information; generating compressed channel information by compressing the wavelet-transformed channel information; and transmitting the compressed channel information to the base station.

The method may further comprise: receiving a wavelet activation indication from the base station, wherein the terminal generates the wavelet-transformed channel information by applying wavelet transform to the channel information according to the wavelet activation indication.

The method may further comprise: receiving information on a plurality of channel information transfer models including a wavelet transform function from the base station; and receiving a model activation indication of one channel information transfer model among the plurality of channel information transfer models from the base station, wherein the terminal generates the wavelet-transformed channel information by activating the one channel information transfer model according to the model activation indication and applying wavelet transform to the channel information.

The one channel information transfer model may include a wavelet transformer and an encoder, the wavelet transformer may perform wavelet transform on the channel information to generate the wavelet-transformed channel information, and the encoder may compress the wavelet-transformed channel information to generate the compressed channel information.

The one channel information transfer model may include a plurality of wavelet transformers and an encoder, the plurality of wavelet transformers may generate the wavelet-transformed channel information by performing iterative wavelet transforms on the channel information, and the encoder may compress the wavelet-transformed channel information to generate the compressed channel information.

The one channel information transfer model may include a wavelet transformer, a first encoder, and a second encoder, the wavelet transformer may generate the wavelet-transformed channel information by performing wavelet transform on the channel information, the first encoder may compress a high frequency band of the wavelet-transformed channel information to generate a part corresponding to a high frequency band of the compressed channel information, and the second encoder may compress a low frequency band of the wavelet-transformed channel information to generate a part corresponding to a low frequency band of the compressed channel information.

The one channel information transfer model may include a first wavelet transformer, a second wavelet transformer, a first encoder, and a second encoder, the first wavelet transformer may receive the channel information and perform primary wavelet transform on the channel information to generate primary wavelet-transformed channel information, the first encoder may compress the primary wavelet-transformed channel information to generate compressed primary channel information, the second wavelet transformer may receive the compressed primary channel information and perform secondary wavelet transform on the compressed primary channel information to generate the wavelet-transformed channel information, and the second encoder may compress the wavelet-transformed channel information to generate the compressed channel information.

The method may further comprise: selecting one wavelet waveform from among wavelet waveforms, wherein the terminal may perform wavelet transform on the channel information by using the selected one wavelet waveform in generating the wavelet-transformed channel information.

The wavelet waveforms may include at least one wavelet waveform among a Morlet wavelet waveform, a Daubechies wavelet waveform, or a biorthogonal wavelet waveform.

The method may further comprise: transmitting information on the selected one wavelet waveform to the base station.

According to a second exemplary embodiment of the present disclosure, a method of a base station may comprise: transmitting a reference signal to a terminal; receiving, from the terminal, compressed channel information obtained through wavelet transform based on the reference signal; decompressing the compressed channel information to generate wavelet-transformed channel information before being compressed; and generating channel information before being wavelet-transformed by applying inverse wavelet transform to the wavelet-transformed channel information.

The method may further comprise: transmitting a wavelet activation indication to the terminal.

The method may further comprise: transmitting information on a plurality of channel information transfer models including a wavelet transform function to the terminal; and transmitting a model activation indication of one channel information transfer model among the plurality of channel information transfer models to the terminal, wherein the base station generates the channel information before being wavelet-transformed by applying inverse wavelet transform to the channel information based on the one channel information transfer model according to the model activation indication.

The method may further comprise: receiving information on one wavelet waveform from the terminal, wherein the base station may generate the channel information before being wavelet-transformed by applying inverse wavelet transform according to the one wavelet waveform to the wavelet-transformed channel information.

According to a third exemplary embodiment of the present disclosure, a terminal may comprise a processor, and the processor may cause the terminal to: receive a reference signal from a base station; generate channel information based on the reference signal; generate wavelet-transformed channel information by applying wavelet transform to the channel information; generate compressed channel information by compressing the wavelet-transformed channel information; and transmit the compressed channel information to the base station.

The processor may further cause the terminal to receive a wavelet activation indication from the base station, wherein the terminal may generate the wavelet-transformed channel information by applying wavelet transform to the channel information according to the wavelet activation indication.

The processor may further cause the terminal to: receive information on a plurality of channel information transfer models including a wavelet transform function from the base station; and receive a model activation indication of one channel information transfer model among the plurality of channel information transfer models from the base station, wherein the terminal may generate the wavelet-transformed channel information by activating the one channel information transfer model according to the model activation indication and applying wavelet transform to the channel information.

The processor may further cause the terminal to select one wavelet waveform from among wavelet waveforms, wherein the terminal may perform wavelet transform on the channel information by using the selected one wavelet waveform in generating the wavelet-transformed channel information.

According to the present disclosure, a terminal may transfer compressed channel information to a base station by compressing channel information while preserving channel information of various frequency bands using wavelet transform. In addition, according to the present disclosure, the terminal may transfer type information of a wavelet waveform used for the wavelet transform to the base station, so that the base station can perform inverse wavelet transform based on the type information.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment of an autoencoder.

FIG. 4 is a waveform diagram illustrating a first exemplary embodiment of a wavelet.

FIG. 5 is a waveform diagram illustrating a second exemplary embodiment of a wavelet.

FIG. 6 is a waveform diagram illustrating a third exemplary embodiment of a wavelet.

FIG. 7 is a conceptual diagram illustrating a first exemplary embodiment of a wavelet transform process.

FIG. 8 is a conceptual diagram illustrating a first exemplary embodiment of an inverse wavelet transform process.

FIG. 9 is a conceptual diagram illustrating a first exemplary embodiment of wavelet transform according to a lifting method.

FIG. 10 is a conceptual diagram illustrating a first exemplary embodiment of inverse wavelet transform according to a lifting method.

FIG. 11A is a graph illustrating a first exemplary embodiment of real parts of eigenvectors of channel state information formed using a cluster delay line A (CDLA) channel model.

FIG. 11B is a graph illustrating a first exemplary embodiment of imaginary parts of eigenvectors of channel state information formed using a cluster delay line A (CDLA) channel model.

FIG. 12A is a graph illustrating a first exemplary embodiment of real parts of eigenvectors of channel state information formed using a cluster delay line B (CDLB) channel model.

FIG. 12B is a graph illustrating a first exemplary embodiment of imaginary parts of eigenvectors of channel state information formed using a cluster delay line B (CDLB) channel model.

FIG. 13 is a block diagram illustrating a first exemplary embodiment of a channel information transfer apparatus using a neural network in a communication system.

FIG. 14 is a block diagram illustrating a second exemplary embodiment of a channel information transfer apparatus using a neural network in a communication system.

FIG. 15 is a block diagram illustrating a third exemplary embodiment of a channel information transfer apparatus using a neural network in a communication system.

FIG. 16 is a block diagram illustrating a fourth exemplary embodiment of a channel information transfer apparatus using a neural network in a communication system.

FIG. 17 is a block diagram illustrating a fifth exemplary embodiment of a channel information transfer apparatus using a neural network in a communication system.

FIG. 18 is a block diagram illustrating a sixth exemplary embodiment of a channel information transfer apparatus using a neural network in a communication system.

FIG. 19 is a conceptual diagram illustrating a second exemplary embodiment of wavelet transform according to a lifting method.

FIG. 20 is a conceptual diagram illustrating a first exemplary embodiment of inverse wavelet transform according to a lifting method.

FIG. 21 is a conceptual diagram illustrating a third exemplary embodiment of wavelet transform according to a lifting method.

FIG. 22 is a conceptual diagram illustrating a first exemplary embodiment of a channel information transfer method using a neural network in a communication system.

FIG. 23 is a conceptual diagram illustrating a second exemplary embodiment of a channel information transfer model using a neural network in a communication system.

FIG. 24 is a conceptual diagram illustrating a third exemplary embodiment of a channel information transfer method using a neural network in a communication system.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

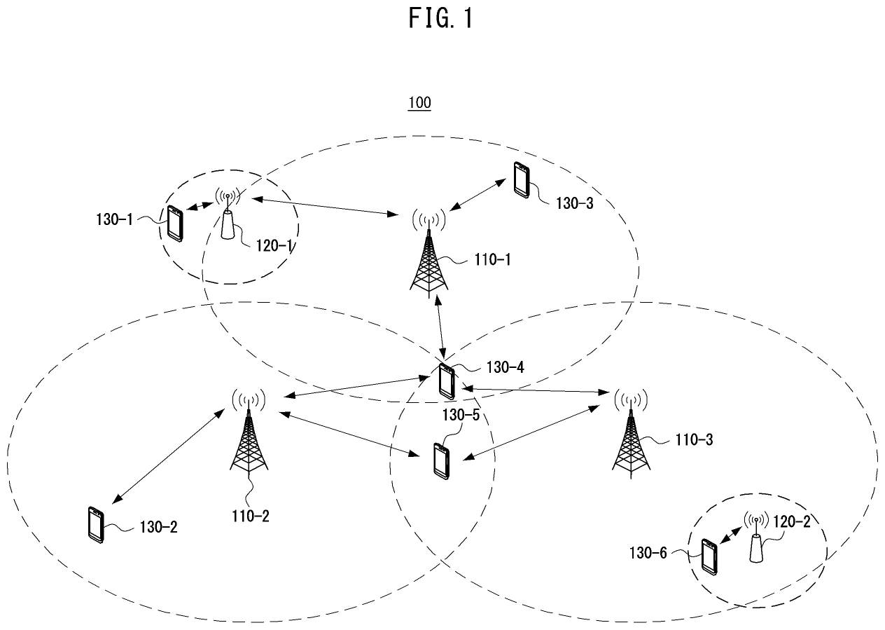

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single-carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have the following structure.

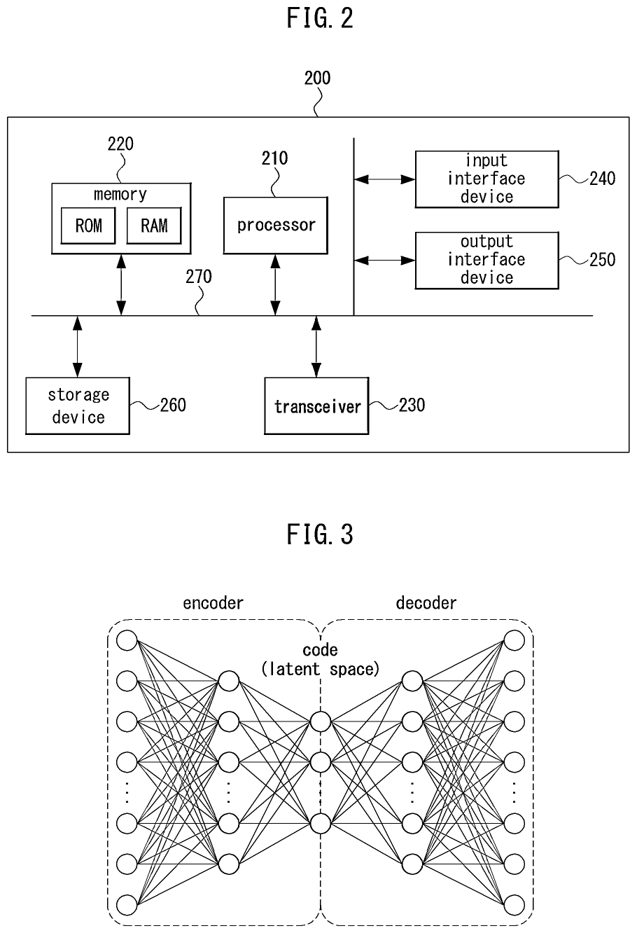

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), relay node, or the like. Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, the 3^{rd} generation partnership project (3GPP) release 18 is discussing technologies for improving a radio environment by utilizing machine learning techniques. The existing method of transferring channel state information based on the 3GPP communication system may use a codebook scheme. In the communication system using the codebook scheme, overhead may gradually increase to represent a communication channel in more detail. In order to overcome such the problem, the 3GPP release 18 is discussing methods of compressing channel state information or information related to channel state information and transferring it by using machine learning techniques. Here, the channel state information or information related to the channel state information may be channel information.

In the above-described methods, the compressed channel information may be decompressed. In the communication system using the above-described methods, overhead of channel information fed back may be reduced, and performance of the communication system can be improved. A discussion on these methods is being conducted as a major use case in ‘AWL for NR Air Interface’, a study item (SI) in the release 18. In particular, the release 18 is discussing how to use an intelligent neural network structure of an autoencoder scheme.

FIG. 3 is a conceptual diagram illustrating a first exemplary embodiment of an autoencoder.

Referring to FIG. 3, an autoencoder may refer to a structure in which an input and an output of a neural network have the same form. Such the autoencoder may consist of an encoder and a decoder. In this case, an output of the encoder may be a latent space, and the latent space may correspond to an input of the decoder. Accordingly, the autoencoder may have a feature of compressing data by reducing the number of dimensions of the latent space as compared to the number of input dimensions and the number of output dimensions. Such the autoencoder may be trained using compressed information of the latent space so as to have a final input and a final output of the same values.

In the process of compressing channel information and decompressing the compressed channel information, the encoder and decoder of the autoencoder may operate at different physical locations. For example, the encoder may be located in a terminal, and the decoder may be located in a base station. The encoder of the terminal may compress channel information, and the terminal may transfer the compressed channel information to the base station. Then, the base station may receive the compressed channel information. Accordingly, the decoder of the base station may obtain the channel information before being compressed by decompressing the compressed channel information.

Meanwhile, a wavelet used for wavelet transform may be a wave having an average value of 0 due to vibration repeating increase and decrease within a predetermined time. The wavelet may exist only for a finite amount of time, unlike sine waves that extend in infinite time. Accordingly, the wavelet may have a band pass characteristic of a specific region in terms of frequency components.

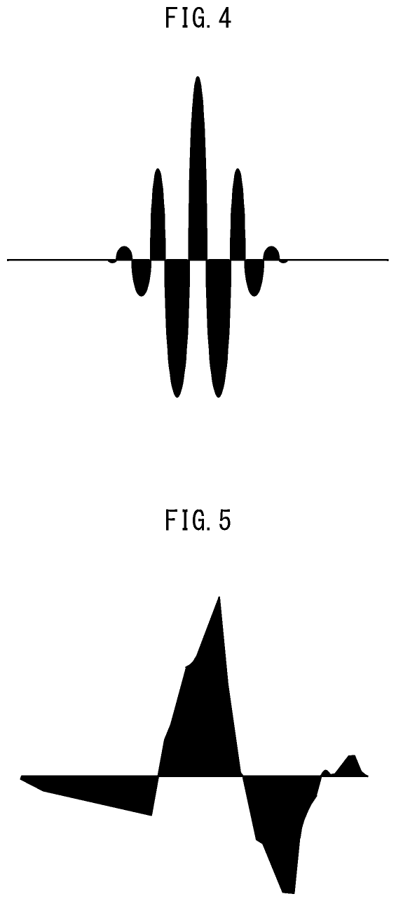

FIG. 4 is a waveform diagram illustrating a first exemplary embodiment of a wavelet.

Referring to FIG. 4, the wavelet may be a Morlet wavelet. Such the Morlet wavelet may be a wavelet developed by Jean Morlet, and may be a wavelet obtained by multiplying a complex exponential function by a Gaussian window. This wavelet may be closely related to human perception, both auditory and visual.

FIG. 5 is a waveform diagram illustrating a second exemplary embodiment of a wavelet.

Referring to FIG. 5, the wavelet may be a Daubechies wavelet. The Daubechies wavelet may be a wavelet discovered by Ingrid Daubechies. Such the Daubechies wavelet may be one of wavelet transforms having arbitrary even points and may be the most simplified form of a Haar transform.

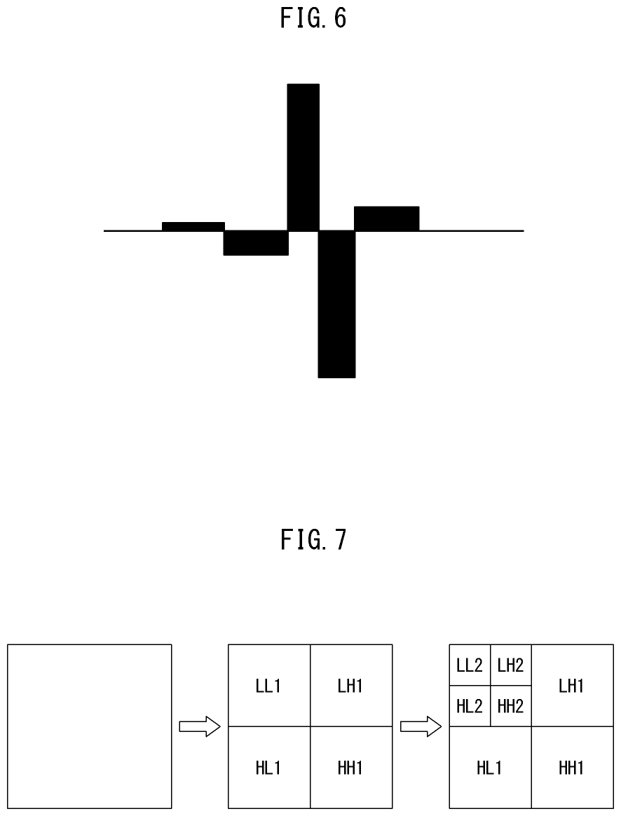

FIG. 6 is a waveform diagram illustrating a third exemplary embodiment of a wavelet.

Referring to FIG. 6, the wavelet may be a biorthogonal wavelet. Such the biorthogonal wavelet may be a wavelet in which associated wavelet transforms are reversible, but not necessarily orthogonal.

Meanwhile, wavelet transform may be a method of decomposing an arbitrary signal using functions defined as the wavelets described above. The wavelet transform may be suitable for representing signals and images using only a small number of coefficients, and may be used for noise reduction or compression in the field of image processing. Using wavelet transform, an original image may be decomposed so as to be represented as images of different frequency bands. The wavelet transform may use a low-pass filter and a high-pass filter to obtain the decomposed images.

FIG. 7 is a conceptual diagram illustrating a first exemplary embodiment of a wavelet transform process.

Referring to FIG. 7, a processor may apply wavelet transform to the entire left image. The processor may apply wavelet transform to the entire image to decompose it into four images of the same size, LL1 image, LH1 image, HL1 image, and HH1 image located in the middle. Here, the LL1 image may include information of a low frequency band in both horizontal and vertical directions. In addition, the LH1 image may include information of a low frequency band in the horizontal direction and information of a high frequency band in the vertical direction. In addition, the HL1 image may include information of a high frequency band in the horizontal direction and information of a low frequency band in the vertical direction. In addition, the HH1 image may include information of a high frequency band in the horizontal and vertical directions.

Further, the processor may apply wavelet transform to the LL1 image to decompose it into four images of the same size, LL2 image, LH2 image, HL2 image, and HH2 image located on the right. Here, the LL2 image may include information of a low frequency band in both horizontal and vertical directions. In addition, the LH2 image may include information of a low frequency band in the horizontal direction and may include information of a high frequency band in the horizontal direction. In addition, the HL2 image may include information of a high frequency band in the horizontal direction and information of a low frequency band in the vertical direction. In addition, the HH2 image may include information of a high frequency band in the horizontal and vertical directions. Conversely, the processor may combine the images of the respective frequency bands into the original image by using inverse wavelet transform.

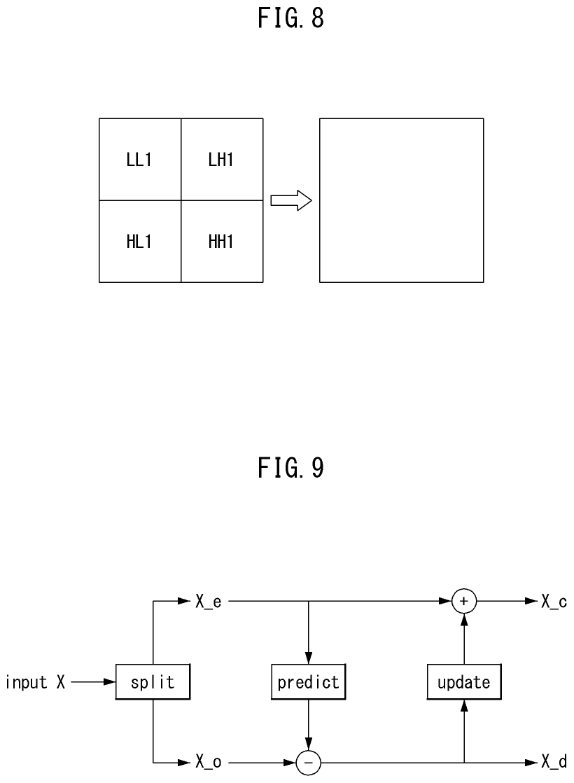

FIG. 8 is a conceptual diagram illustrating a first exemplary embodiment of an inverse wavelet transform process.

Referring to FIG. 8, a processor may apply inverse wavelet transform to the LL1 image, LH1 image, HL1 image, and HH1 image on the left side. The processor may generate an entire image positioned on the right side by applying inverse wavelet transform to the LL1 image, the LH1 image, the HL1 image, and the HH1 image.

Meanwhile, a lifting method is a method of performing wavelet transform and may be a second generation wavelet generation method. The lifting method may be performed by separating wavelet transform into three processes: a split process, a predict process, and an update process.

FIG. 9 is a conceptual diagram illustrating a first exemplary embodiment of wavelet transform according to a lifting method.

Referring to FIG. 9, a processor may divide input signals X into even-numbered samples X_e and odd-numbered samples X_o in a split process. In a predict process, the processor may calculate values obtained by passing the even-numbered samples X_e through a prediction filter. Further, the processor may calculate high-frequency coefficients X_d in a high-frequency region by calculating differences between the odd-numbered samples X_o and the values obtained by the prediction filtering. In addition, the processor may calculate updated high-frequency coefficients by passing the high-frequency coefficients X_d through an update filter in an update process. Thereafter, the processor may calculate low-frequency coefficients X_c in a low-frequency region by summing the even-numbered samples X_e and the updated high-frequency coefficients X_d.

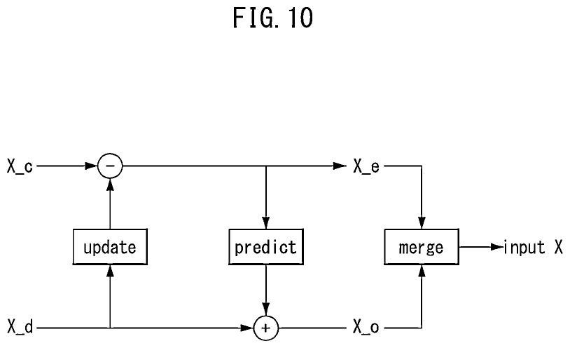

FIG. 10 is a conceptual diagram illustrating a first exemplary embodiment of inverse wavelet transform according to a lifting method.

Referring to FIG. 10, a processor may calculate updated high-frequency coefficients by passing the high-frequency coefficients X_d of the high frequency region through an update filter in an update process. In addition, the processor may calculate differences between the updated high-frequency coefficients and the low-frequency coefficients X_c in the low-frequency region to calculate the even-numbered samples X_e. Then, the processor may perform a predict process to generate even-numbered samples that have passed a prediction filter from the even-numbered samples X_e, and add the predicted even-numbered samples to the high-frequency coefficients X_d to obtain the odd-numbered samples X_o. Thereafter, the processor may generate and output the input signals X by merging the even-numbered samples X_e and the odd-numbered samples X_o in a merge process.

The present disclosure proposes a method for constructing an artificial neural network for preventing performance degradation due to a change in channel environment when an intelligent channel information compression and decompression technique is used in a cellular communication system. Specifically, the present disclosure proposes a method of preserving and learning information of various frequency bands of channel information using wavelet transform. In addition, the present disclosure proposes a method of configuring related information between a terminal and a base station to use wavelet transform.

Meanwhile, a neural network model used for intelligent compression and recompression of channel information may use channel state information or related channel state information obtained by extracting characteristics from the channel state information as input data for compression. The related channel state information obtained by extracting characteristics from the channel state information may be representatively an eigenvector of the channel state information. Here, the channel state information and the eigenvector of the channel state information may be channel information. Depending on a channel environment, channel information used for compression may have different characteristics. The structure of the neural network may consider performance improvement in various types of channel environments in a learning process.

For example, a processor may generate an eigenvector of channel state information using clustered delay line (CDL) channel models used in the 3GPP.

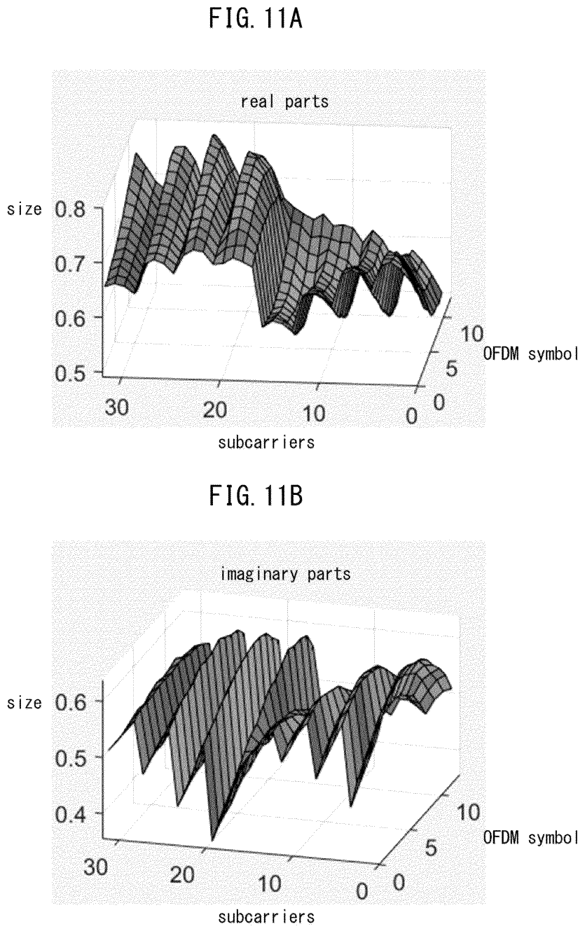

FIG. 11A is a graph illustrating a first exemplary embodiment of real parts of eigenvectors of channel state information formed using a cluster delay line A (CDLA) channel model, and FIG. 11B is a graph illustrating a first exemplary embodiment of imaginary parts of eigenvectors of channel state information formed using a cluster delay line A (CDLA) channel model.

Referring to FIGS. 11A and 11B, the eigenvectors of channel state information formed using the CDLA channel model may have a gentle shape. The eigenvectors may have an OFDM symbol index on one axis, a subcarrier index on another axis, and a size on another axis.

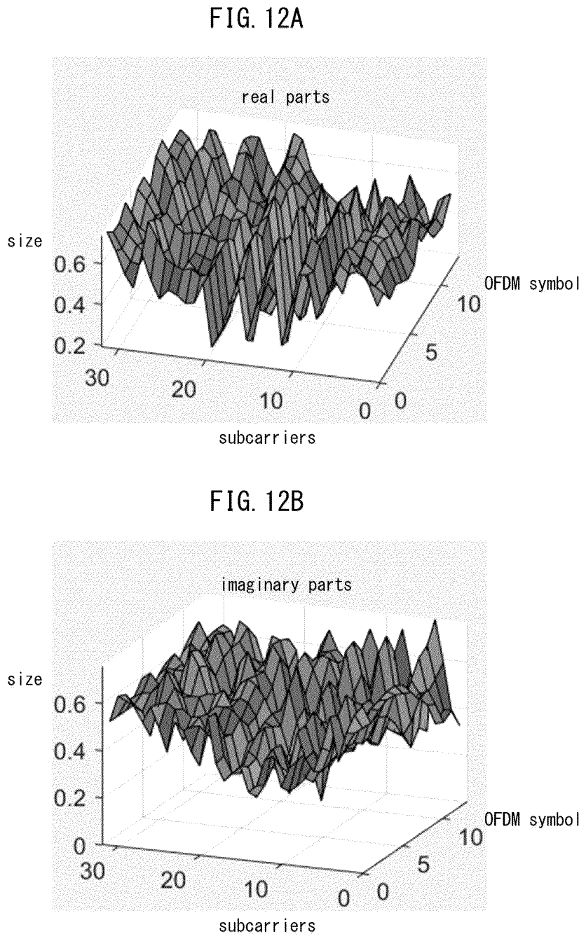

FIG. 12A is a graph illustrating a first exemplary embodiment of real parts of eigenvectors of channel state information formed using a cluster delay line B (CDLB) channel model, and FIG. 12B is a graph illustrating a first exemplary embodiment of imaginary parts of eigenvectors of channel state information formed using a cluster delay line B (CDLB) channel model.

Referring to FIGS. 12A and 12B, the eigenvectors of channel state information formed using the CDLB channel model may have poor continuity with neighboring data. In addition, sharper parts, which are parts with large changes, may appear in the eigenvectors of the channel state information formed using the CDLB channel model. As such, the sharper part resulting from a large change compared with surroundings in the eigenvectors of the channel state information formed using the CDLB channel model may correspond to relatively high frequency components.

In the above-described situation, an autoencoder having an intelligent neural network structure may compress channel information to transfer the channel information. In this case, a dimensionality of a latent space of the autoencoder may not be sufficiently large. Accordingly, components corresponding to a high frequency may not be preserved in a compression process of the autoencoder, and the performance of the autoencoder may decrease. In addition, in the process of transferring the channel information, the autoencoder may use a convolution-based convolution neural network (CNN). Such the CNN is a neural network developed in an image learning process, and may guarantee continuity with surrounding data to some extent. In contrast, channel information such as an eigenvector is relatively out of continuity with surrounding data, and methods for supplementing this may be required.

In this reason, the present disclosure proposes a method of improving performance by preserving high frequency components by adding wavelet transform to a channel information transfer neural network in order to compensate for the disadvantages of the intelligent neural network structure. In this regard, a first method may be a method of using wavelet transform in pre-processing and post-processing of the intelligent model structure.

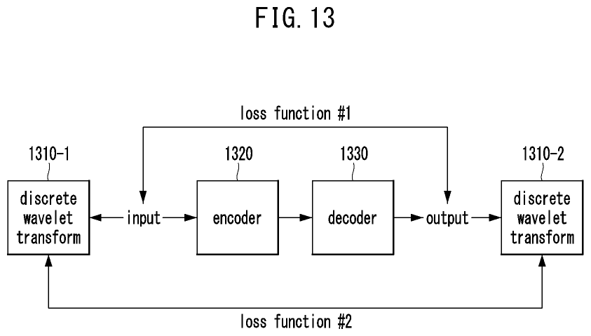

FIG. 13 is a block diagram illustrating a first exemplary embodiment of a channel information transfer apparatus using a neural network in a communication system.

Referring to FIG. 13, a channel information transfer apparatus may include a first discrete wavelet transformer 1310-1, an encoder 1320, a decoder 1330, and a second discrete wavelet transformer 1310-2. The channel information transfer apparatus may be installed and trained in a communication node. The communication node may be, for example, a terminal or a base station. In addition, the channel information transfer apparatus may be represented as a channel information transfer model.

In the channel information transfer apparatus, the first discrete wavelet transformer 1310-1 may decompose channel information before being compressed into channel information of different frequency bands (e.g., LL, LH, HL, and HH) by performing discrete wavelet transform thereon. Here, the channel information may be channel state information or an eigenvector obtained by extracting characteristics from the channel state information.

Then, the encoder 1320 may generate compressed channel information by compressing the channel information, and the decoder 1330 may generate restored channel information by decompressing the compressed channel information. In addition, the second discrete wavelet transformer 1310-2 may decompose the restored channel information into channel information of different frequency bands (e.g., LL, LH, HL, and HH) by performing discrete wavelet transform on the restored channel information.

Meanwhile, the communication node may calculate a loss function #1 using the channel information before being compressed and the restored channel information. The communication node may train the encoder 1320 and the decoder 1330 so that the loss function #1 is minimized. In addition, the communication node may calculate a loss function #2 using the channel information of different frequency bands generated by performing wavelet transform on the channel information before being compressed and the channel information of different frequency bands generated by performing wavelet transform on the restored channel information. The communication node may adjust the first discrete wavelet transformer 1310-1 and the second discrete wavelet transformer 1310-2 so that the loss function #2 is minimized.

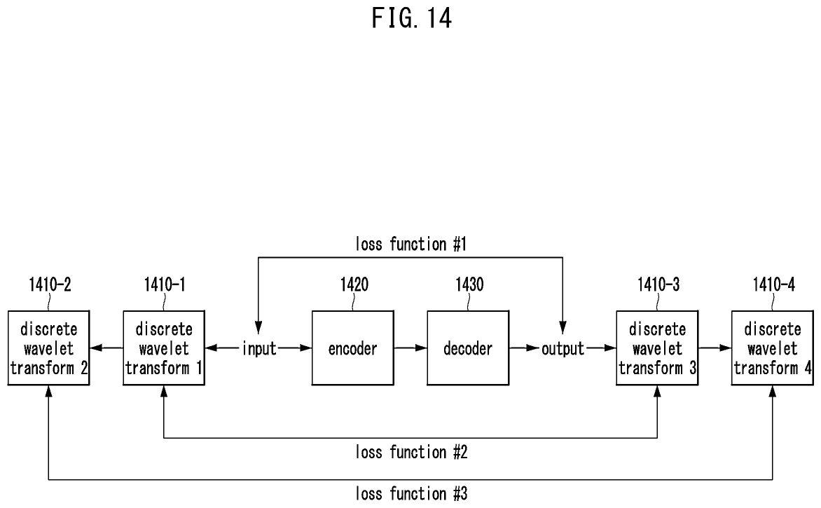

FIG. 14 is a block diagram illustrating a second exemplary embodiment of a channel information transfer apparatus using a neural network in a communication system.

Referring to FIG. 14, a channel information transfer apparatus may include a first discrete wavelet transformer 1410-1, a second discrete wavelet transformer 1410-2, an encoder 1420, a decoder 1430, a third discrete wavelet transformer 1410-3, and a fourth discrete wavelet transformer 1410-4. The channel information transfer apparatus may be installed and trained in a communication node. The communication node may be, for example, a terminal or a base station. In addition, the channel information transfer apparatus may be represented as a channel information transfer model.

Here, the first discrete wavelet transformer 1410-1 may primarily decompose channel information before being compressed into channel information of different frequency bands (e.g., LL, LH, HL, and HH) by performing discrete wavelet transform thereon. In addition, the second discrete wavelet transformer 1410-2 may secondarily decompose each of the channel information of different frequency bands (e.g., LL, LH, HL, and HH) into channel information of different frequency bands (e.g., LL, LH, HL, and HH) by performing discrete wavelet transform. Of course, the second discrete wavelet transformer 1410-2 may decompose channel information of any one frequency band among the channel information of different frequency bands (e.g., LL, LH, HL, and HH) decomposed by the first discrete wavelet transformer 1410-1 into channel information of different frequency bands (e.g., LL, LH, HL, and HH) by performing discrete wavelet transform thereon.

The encoder 1420 may generate compressed channel information by compressing the channel information, and then the decoder 1430 may generate restored channel information by decompressing the compressed channel information.

Then, the third discrete wavelet transformer 1410-3 may primarily decompose the restored channel information into channel information of different frequency bands (e.g., LL, LH, HL, and HH) by performing discrete wavelet transform thereon. In addition, the fourth discrete wavelet transformer 1410-4 may secondarily decompose each of the channel information of different frequency bands (e.g., LL, LH, HL, and HH) decomposed by the third discrete wavelet transformer 1410-3 into channel information of different frequency bands (e.g., LL, LH, HL, and HH) by performing discrete wavelet transform thereon. Of course, the fourth discrete wavelet transformer 1410-4 may decompose channel information of any one frequency band among the channel information of the different frequency bands (e.g., LL, LH, HL, and HH) decomposed by the third discrete wavelet transformer 1410-3 into channel information of different frequency bands (e.g., LL, LH, HL, and HH) by performing discrete wavelet transform thereon.

Meanwhile, the communication node may calculate a loss function #1 using the channel information before being compressed and the restored channel information. The communication node may train the encoder 1420 and the decoder 1430 so that the loss function #1 is minimized. In addition, the communication node may calculate a loss function #2 using the channel information of different frequency bands generated by performing wavelet transform on the channel information before being compressed and the channel information of different frequency bands generated by performing wavelet transform on the restored channel information. The communication node may adjust the first discrete wavelet transformer 1410-1 and the third discrete wavelet transformer 1410-3 so that the loss function #2 is minimized. In addition, the communication node may calculate a loss function #3 using the channel information of different bands generated by secondary discrete wavelet transform on the channel information before being compressed and the channel information of different bands generated by secondary discrete wavelet transform on the restored channel information. The communication node may adjust the second discrete wavelet transformer 1410-2 and the fourth discrete wavelet transformer 1410-4 so that the loss function #3 is minimized.

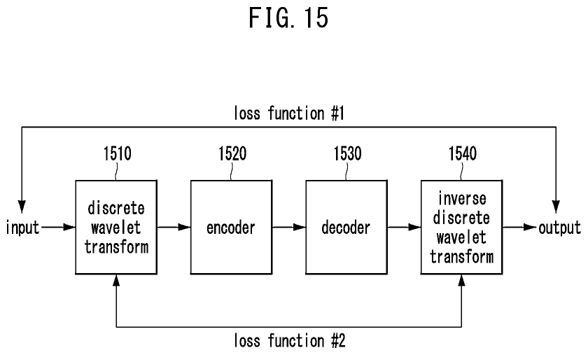

FIG. 15 is a block diagram illustrating a third exemplary embodiment of a channel information transfer apparatus using a neural network in a communication system.

Referring to FIG. 15, a channel information transfer apparatus may include a discrete wavelet transformer 1510, an encoder 1520, a decoder 1530, and an inverse discrete wavelet transformer 1540. The channel information transfer apparatus may be installed and learned in a communication node. The communication node may be, for example, a terminal or a base station. In addition, the channel information transfer apparatus may be represented as a channel information transfer model. Here, the channel information transfer apparatus of FIG. 15 may be, for example, modeled as a first type of channel information transfer model.

Here, the discrete wavelet transformer 1510 may decompose channel information before being compressed into channel information of different frequency bands (e.g., LL, LH, HL, and HH) by performing discrete wavelet transform thereon. The encoder 1520 may generate compressed channel information of different frequency bands by compressing the channel information of different frequency bands, and then the decoder 1530 may generate restored channel information of different frequency bands by decompressing the compressed channel information of different frequency bands. The inverse discrete wavelet transformer 1540 may generate inverse-discrete-wavelet-transformed channel information by performing inverse discrete wavelet transform on the restored channel information of different frequency bands.

Meanwhile, the communication node may calculate a loss function #1 using the channel information before being compressed and the restored channel information. The communication node may train the encoder 1520 and the decoder 1530 so that the loss function #1 is minimized. In addition, the communication node may adjust the discrete wavelet transformer 1510 and inverse discrete wavelet transformer 1540 so that the loss function #1 is minimized. In addition, the communication node may calculate a loss function #2 using the channel information of different frequency bands generated by performing discrete wavelet transform on the channel information before being compressed and the restored channel information of different frequency bands. The communication node may adjust the discrete wavelet transformer 1510 so that the loss function #2 is minimized.

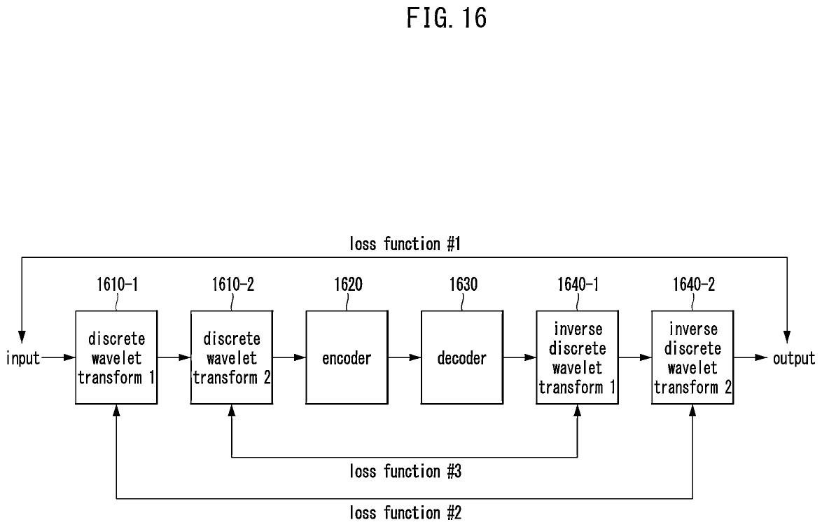

FIG. 16 is a block diagram illustrating a fourth exemplary embodiment of a channel information transfer apparatus using a neural network in a communication system.

Referring to FIG. 16, a channel information transfer apparatus may include a first discrete wavelet transformer 1610-1, a second discrete wavelet transformer 1610-2, an encoder 1620, a decoder 1630, a first inverse discrete wavelet transformer 1640-1, and a second inverse discrete wavelet transformer 1640-2. The channel information transfer apparatus may be installed and trained in a communication node. The communication node may be, for example, a terminal or a base station. In addition, the channel information transfer apparatus may be represented as a channel information transfer model. The channel information transfer apparatus of FIG. 16 may be modeled as a second type of channel information transfer model.

Here, the first discrete wavelet transformer 1610-1 may primarily decompose channel information before being compressed into primary wavelet-transformed channel information of different frequency bands (e.g., LL, LH, HL, and HH) by performing discrete wavelet transform thereon. Then, the second discrete wavelet transformer 1610-2 may secondarily decompose the primary wavelet-transformed channel information of different frequency bands (e.g., LL, LH, HL, and HH) into secondary wavelet-transformed channel information of different frequency bands (e.g., LL, LH, HL, and HH) by performing discrete wavelet transform thereon. Of course, the second discrete wavelet transformer 1610-2 may decompose channel information of any one frequency band among the channel information of different frequency bands (e.g., LL, LH, HL, and HH) decomposed by the first discrete wavelet transformer 1610-1 into channel information of different frequency bands (e.g., LL, LH, HL, and HH) by performing discrete wavelet transform thereon.

The encoder 1620 may generate compressed secondary wavelet-transformed channel information by compressing the secondary wavelet-transformed channel information, and then the decoder 1630 may generated restored secondary wavelet-transformed channel information by decompressing the compressed secondary wavelet-transformed channel information.

Then, the first inverse discrete wavelet transformer 1640-1 may generate primary inverse-wavelet-transformed channel information by performing inverse discrete wavelet transform on the restored secondary wavelet-transformed channel information before being compressed. In addition, the second inverse discrete wavelet transformer 1640-1 may generate secondary wavelet-inverse-transformed channel information by performing inverse discrete wavelet transform on the primary inverse-wavelet-transformed channel information generated by the first inverse discrete wavelet transformer 1640-1.

Meanwhile, the communication node may calculate a loss function #1 using the channel information before being compressed and the restored channel information. The communication node may train the encoder 1620 and the decoder 1630 so that the loss function #1 is minimized. In addition, the communication node may adjust the first discrete wavelet transformer 1610-1, the second discrete wavelet transformer 1610-2, the first inverse discrete wavelet transformer 1640-1, and the second inverse discrete wavelet transformer 1640-2 so that the loss function #1 is minimized.

In addition, the communication node may calculate a loss function #2 using the primary wavelet-transformed channel information and the primary inverse-wavelet-transformed channel information. The communication node may adjust the first discrete wavelet transformer 1610-1, the second discrete wavelet transformer 1610-2, and the first inverse discrete wavelet transformer 1640-1 so that the loss function #2 is minimized.

In addition, the communication node may calculate a loss function #3 using the secondary wavelet-transformed channel information and the restored secondary wavelet-transformed channel information. The communication node may adjust the second discrete wavelet transformer 1610-2 so that the loss function #3 is minimized.

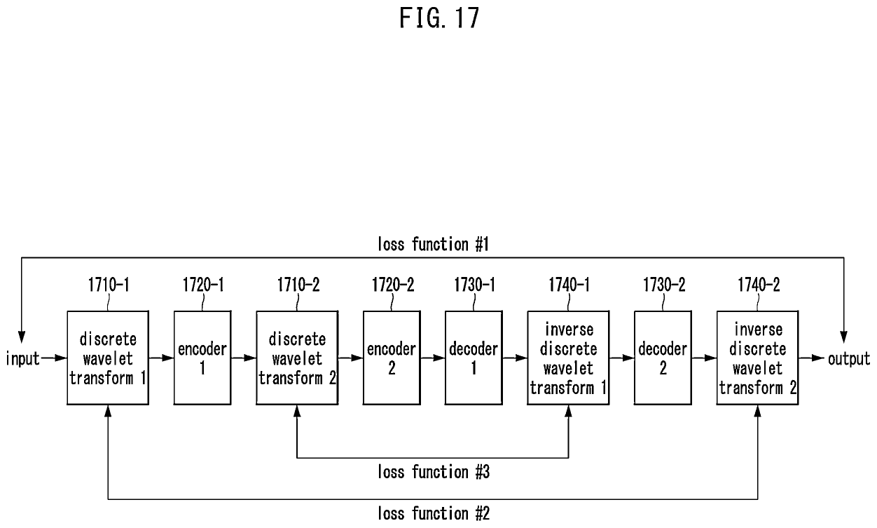

FIG. 17 is a block diagram illustrating a fifth exemplary embodiment of a channel information transfer apparatus using a neural network in a communication system.

Referring to FIG. 17, a channel information transfer apparatus may include a first discrete wavelet transformer 1710-1, a second discrete wavelet transformer 1710-2, a first encoder 1720-1, a second encoder 1720-2, a first decoder 1730-1, a second decoder 1730-2, a first inverse discrete wavelet transformer 1740-1, and a second inverse discrete wavelet transformer 1740-2. The channel information transfer apparatus may be installed and trained in a communication node. The communication node may be, for example, a terminal or a base station. In addition, the channel information transfer apparatus may be represented as a channel information transfer model. The channel information transfer apparatus of FIG. 17 may be modeled as a third type of channel information transfer model.

Here, the first discrete wavelet transformer 1710-1 may primarily decompose channel information before being compressed into primary wavelet-transformed channel information of different frequency bands (e.g., LL, LH, HL, and HH) by performing discrete wavelet transform thereon. In addition, the first encoder 1720-1 may compress the primary wavelet-transformed channel information to generate compressed primary wavelet-transformed channel information. The second discrete wavelet transformer 1710-2 may secondarily decompose the compressed primary wavelet-transformed channel information into secondary wavelet-transformed channel information of different frequency bands (e.g., LL, LH, HL, HH) by performing discrete wavelet transform thereon.

Of course, the second discrete wavelet transformer 1710-2 may decompose channel information of any one frequency band among the channel information of different frequency bands (e.g., LL, LH, HL, HH) decomposed by the first discrete wavelet transformer 1710-1 into channel information of different frequency bands (e.g., LL, LH, HL, HH) by performing discrete wavelet transform thereon. The second encoder 1720-2 may generate compressed secondary wavelet-transformed channel information by compressing the secondary wavelet-transformed channel information, and then the first decoder 1730-1 may generate restored primary wavelet-transformed channel information by decompressing the compressed secondary wavelet-transformed channel information. Here, the restored primary wavelet-transformed channel information may correspond to the secondary wavelet-transformed channel information before being compressed.

In addition, the first inverse discrete wavelet transformer 1740-1 may generate primary inverse-wavelet-transformed channel information by performing inverse discrete wavelet transform on the restored primary wavelet-transformed channel information. Here, the primary inverse-wavelet-transformed channel information may correspond to the compressed primary wavelet-transformed channel information.

Then, the second decoder 1730-2 may generate restored secondary wavelet-transformed channel information by decompressing the primary inverse-wavelet-transformed channel information. Here, the restored secondary wavelet-transformed channel information may correspond to the primary wavelet-transformed channel information before being compressed.

In addition, the second inverse discrete wavelet transformer 1740-2 may generate secondary inverse-wavelet-transformed channel information by performing inverse discrete wavelet transform on the restored secondary wavelet-transformed channel information. Here, the secondary inverse-wavelet-transformed channel information may correspond to the channel information before being primarily wavelet-transformed.

Meanwhile, the communication node may calculate a loss function #1 using the channel information before being compressed and the restored channel information. The communication node may train the first and second encoders 1720-1 and 1720-2 and the first and second decoders 1730-1 and 1730-2 so that the loss function #1 is minimized. In addition, the communication node may adjust the first discrete wavelet transformer 1710-1, the second discrete wavelet transformer 1710-2, the first inverse discrete wavelet transformer 1740-1, and the second inverse discrete wavelet transformer 1740-2 so that the loss function #1 is minimized.

In addition, the communication node may calculate a loss function #2 using the primary wavelet-transformed channel information and the restored secondary wavelet-transformed channel information. The communication node may adjust the first discrete wavelet transformer 1710-1, the second discrete wavelet transformer 1710-2, and the first inverse discrete wavelet transformer 1740-1 so that the loss function #2 is minimized.

In addition, the communication node may calculate a loss function #3 using the secondary wavelet-transformed channel information and the restored primary wavelet-transformed channel information. The communication node may adjust the second inverse discrete wavelet transformer 1710-2 so that the loss function #3 is minimized.

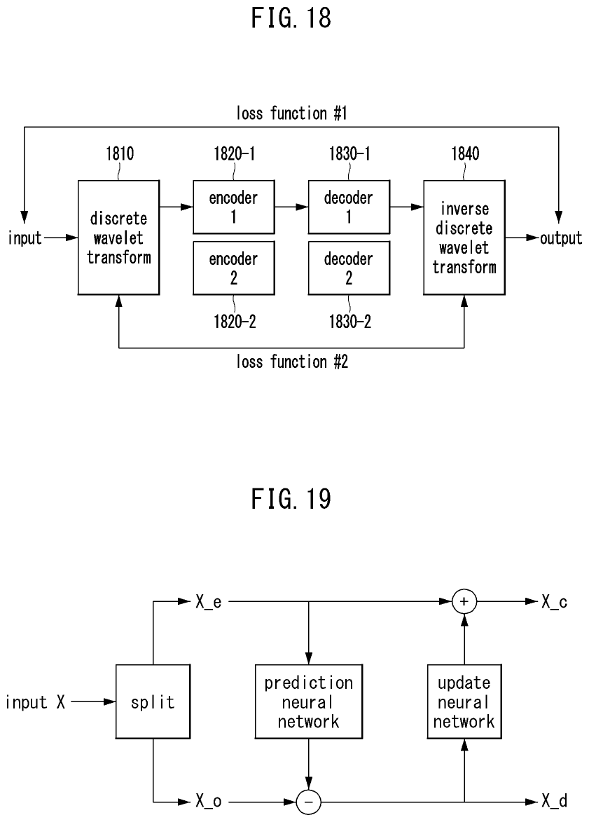

FIG. 18 is a block diagram illustrating a sixth exemplary embodiment of a channel information transfer apparatus using a neural network in a communication system.

Referring to FIG. 18, a channel information transfer apparatus may include a discrete wavelet transformer 1810, a first encoder 1820-1, a second encoder 1820-2, a first decoder 1830-1, and a second decoder 1830-2, and an inverse discrete wavelet transformer 1840. The channel information transfer apparatus may be installed and trained in a communication node. The communication node may be, for example, a terminal or a base station. In addition, the channel information transfer apparatus may be represented as a channel information transfer model. The channel information transfer apparatus of FIG. 18 may be modeled as a fourth type of channel information transfer model.

Here, the discrete wavelet transformer 1810 may decompose channel information before being compressed into wavelet-transformed channel information of different frequency bands (e.g., LL, LH, HL, and HH) by performing discrete wavelet transform thereon. In addition, the first encoder 1820-1 may generate compressed first part wavelet-transformed channel information by compressing a first part (e.g., the LL part and the LH part) of the wavelet-transformed channel information. On the other hand, the second encoder 1820-2 may generate compressed second part wavelet-transformed channel information by compressing a second part (e.g., the HL part and the HH part) of the wavelet-transformed channel information.

Then, the first decoder 1830-1 may generate first part wavelet-transformed channel information before being compressed by decompressing the compressed first part wavelet-transformed channel information. On the other hand, the second decoder 1830-2 may generate second part wavelet-transformed channel information before being compressed by decompressing the compressed second part wavelet-transformed channel information.

Then, the inverse discrete wavelet transformer 1840 may generate inverse-wavelet-transformed channel information by performing inverse discrete wavelet transform on the first part wavelet-transformed channel information and the second part wavelet-transformed channel information. Here, the inverse-wavelet-transformed channel information may correspond to the channel information before being compressed.

Meanwhile, the communication node may calculate a loss function #1 using the channel information before being compressed and the restored channel information. The communication node may train the first and second encoders 1820-1 and 1820-2 and the first and second decoders 1830-1 and 1830-2 so that the loss function #1 is minimized. In addition, the communication node may adjust the discrete wavelet transformer 1810 and the inverse discrete wavelet transformer 1840 so that the loss function #1 is minimized.

In addition, the communication node may calculate a loss function #2 using the first and second part wavelet-transformed channel information and the restored first and second part wavelet-transformed channel information. The communication node may adjust the discrete wavelet transformer 1810 and the inverse discrete wavelet transformer 1840 so that the loss function #2 is minimized.

FIG. 19 is a conceptual diagram illustrating a second exemplary embodiment of wavelet transform according to a lifting method.

Referring to FIG. 19, the discrete wavelet transformer may divide input signals X into even-numbered samples X_e and odd-numbered samples X_o in a split process. In a predict process, the discrete wavelet transformer may calculate values obtained by passing the even-numbered samples X_e through a prediction filter using a prediction neural network. Further, the discrete wavelet transformer may calculate high-frequency coefficients X_d of a high-frequency band by calculating differences between the odd-numbered samples X_o and the values obtained through the prediction filtering. In addition, the discrete wavelet transformer may update the high-frequency coefficients X_d by using an update neural network in an update process. Thereafter, the discrete wavelet transformer may calculate low-frequency coefficients X_c of a low-frequency band by summing the even-numbered samples X_e and the updated high-frequency coefficients X_d.

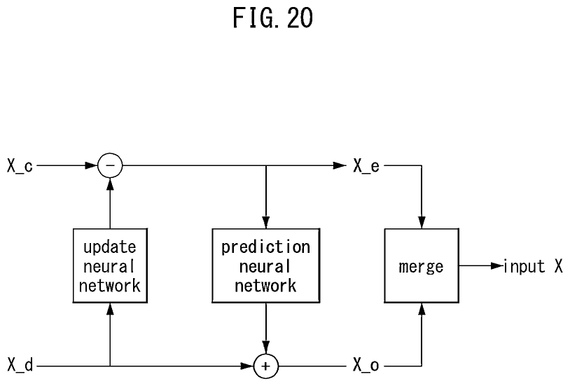

FIG. 20 is a conceptual diagram illustrating a first exemplary embodiment of inverse wavelet transform according to a lifting method.

Referring to FIG. 20, the inverse discrete wavelet transformer may calculate updated high-frequency coefficients by updating the high-frequency coefficients X_d of the high-frequency band using an update neural network in an update process. Further, the inverse discrete wavelet transformer may calculate even-numbered samples X_e by calculating differences between the updated high frequency coefficients and the low-frequency coefficients X_c of the low-frequency band. In addition, the inverse discrete wavelet transformer may generate predicted even-numbered samples from the even-numbered samples X_e by performing a prediction process using a prediction neural network, and adding the predicted even-numbered samples to the high-frequency coefficients X_d. Thereafter, the inverse discrete wavelet transformer may generate and output input signals X by merging the even-numbered samples X_e and the odd-numbered samples X_o in a merge process.

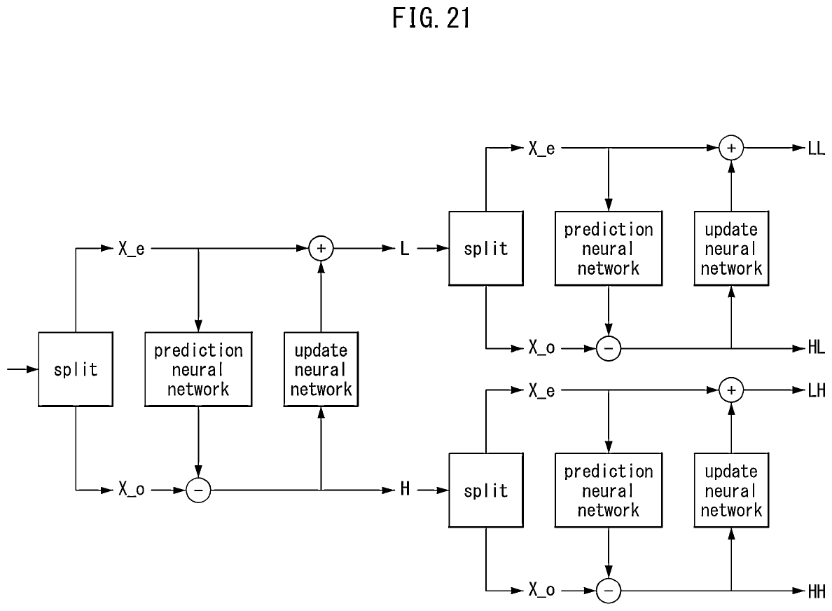

FIG. 21 is a conceptual diagram illustrating a third exemplary embodiment of wavelet transform according to a lifting method.

Referring to FIG. 21, the discrete wavelet transformer may divide input signals X into even-numbered samples X_e and odd-numbered samples X_o in a primary split process. In a primary predict process, the discrete wavelet transformer may primarily predict values obtained by passing the even-numbered samples X_e through a prediction filter using a prediction neural network. In addition, the discrete wavelet transformer may calculate high-frequency coefficients X_d of a high-frequency band by calculating differences between the odd-numbered samples X_o and the primarily-predicted values. In addition, the discrete wavelet transformer may calculate primarily-updated high frequency coefficients by updating the high-frequency coefficients X_d using an update neural network in a primary update process. Thereafter, the discrete wavelet transformer may calculate low-frequency coefficients X_c of a low-frequency band by summing the even-numbered samples X_e and the updated high-frequency coefficients X_d.

Then, the discrete wavelet transformer may divide input signals of the low-frequency band into even-numbered samples X_e and odd-numbered samples X_o in a secondary-first split process. In a secondary-first predict process, the discrete wavelet transformer may predict values obtained by passing the even-numbered samples X_e through a prediction neural network. The discrete wavelet transformer may calculate high-low frequency coefficients of a high-low frequency band by calculating differences between the odd-numbered samples X_o and the predicted values. In addition, the discrete wavelet transformer may update the high-frequency coefficients X_d using an update neural network in a secondary-first update process. Then, the discrete wavelet transformer may calculate the low-low frequency coefficients of the low-frequency band by summing the even-numbered samples X_e and the updated high-frequency coefficients X_d.

Then, the discrete wavelet transformer may divide input signals of the high frequency band into even-numbered samples X_e and odd-numbered samples X_o in a secondary-second split process. In a secondary-second predict process, the discrete wavelet transformer may perform secondary-second prediction by passing the even-numbered samples X_e through a prediction filter using a prediction neural network. In addition, the discrete wavelet transformer may calculate the high-high frequency coefficients of the high-frequency band by calculating differences between the odd-numbered samples X_o and the predicted values. In addition, the discrete wavelet transformer may update the high-frequency coefficients X_d using an update neural network in a secondary-second update process. Then, the discrete wavelet transformer may calculate the low-high frequency coefficients of the low-high frequency band by summing the even-numbered samples X_e and the updated high-frequency coefficients X_d.

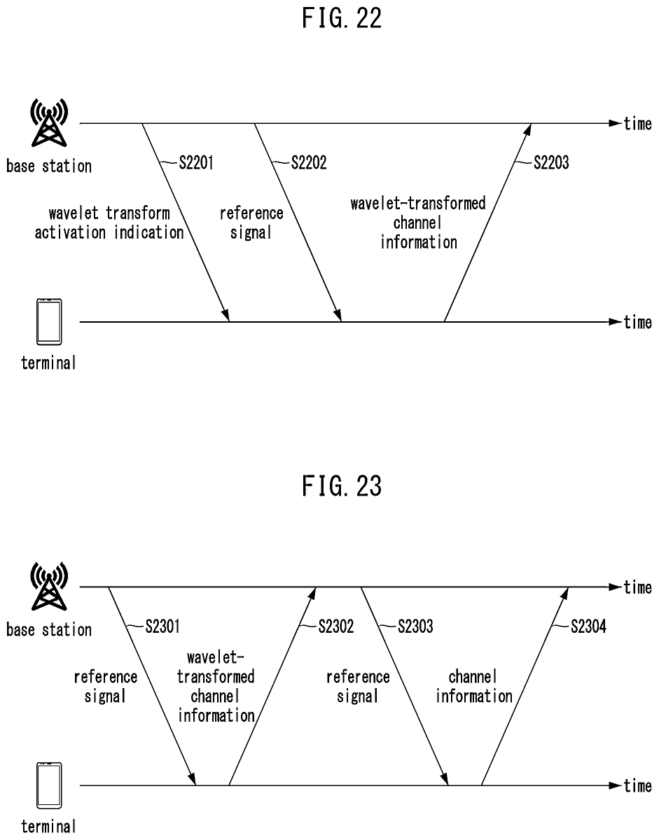

FIG. 22 is a conceptual diagram illustrating a first exemplary embodiment of a channel information transfer method using a neural network in a communication system.

Referring to FIG. 22, in a channel information transfer method, a base station may transmit a wavelet transform activation indication signal to a terminal (S2201). Then, the terminal may receive the wavelet transform activation indication signal from the base station. Thereafter, the base station may transmit a reference signal to the terminal (S2202). Then, the terminal may receive the reference signal from the base station, and generate channel state information based on the received reference signal. The terminal may generate wavelet-transformed channel state information using wavelet transform. In other words, the terminal may generate the wavelet-transformed channel information using wavelet transform.

Then, the terminal may compress the wavelet-transformed channel information using an encoder, and transmit the compressed wavelet-transformed channel information to the base station (S2203). The base station may receive the compressed wavelet-transformed channel information from the terminal, and the base station may obtain the wavelet-transformed channel information before being compressed by decompressing the compressed wavelet-transformed channel information through a decoder. Thereafter, the base station may perform inverse wavelet transform to obtain the channel information before being wavelet-transformed. In other words, the base station may obtain the channel state information before being wavelet-transformed by performing inverse wavelet transform.

Here, the base station may deliver information on channel information transfer models to the terminal. Then, the terminal may receive the information on channel information transfer models from the base station, and store and manage the information on channel information transfer models.

In addition, when the base station transmits the wavelet transform activation indication signal to the terminal, the base station may transmit type information of a channel information transfer model desired to be activated. Then, the terminal may receive the wavelet transform activation indication signal from the base station. In this case, the terminal may receive the type information of the channel information transfer model desired to be activated from the base station. Accordingly, the terminal may identify the wavelet transform activation indication from the base station and the type of the channel information transfer model desired to be used. The terminal may perform wavelet transform on the channel information by activating the channel information transfer model according to the identified type information of the channel information transfer model.

Alternatively, the base station may transmit type information of a channel information transfer model desired to be activated. Then, the terminal may receive the type information of the channel information transfer model desired to be activated from the base station. Accordingly, the terminal may identify the type of channel information transfer model desired to be used from the base station. The terminal may perform wavelet transform on the channel information by activating a channel information transfer model according to the identified type information of the channel information transfer model.

FIG. 23 is a conceptual diagram illustrating a second exemplary embodiment of a channel information transfer model using a neural network in a communication system.

Referring to FIG. 23, the base station may transmit a reference signal to the terminal (S2301). Then, the terminal may receive the reference signal from the base station and generate channel information based on the received reference signal. Then, the terminal may generate wavelet-transformed channel information using wavelet transform. Thereafter, the terminal may compress the wavelet-transformed channel information with an encoder to generate compressed wavelet-transformed channel information. Thereafter, the terminal may transfer the compressed wavelet-transformed channel information to the base station (S2302). In this case, the terminal may transmit wavelet transform use indication information to the base station together. Here, the wavelet transform use indication information may be a wavelet transform use indicator. Then, the base station may receive the compressed wavelet-transformed channel information from the terminal. In addition, the base station may receive the wavelet transform use indication information from the terminal. Accordingly, the base station may know that wavelet transform is to be used in the terminal.

Then, the base station may obtain the wavelet-transformed channel information before being compressed by decompressing the compressed wavelet-transformed channel information through the decoder. Thereafter, the base station may perform inverse wavelet transform to obtain the channel information before being wavelet-transformed. In other words, the base station may obtain the channel state information before being wavelet-transformed by inverse wavelet transform.

Here, the base station may deliver information on channel information transfer models to the terminal, and the terminal may receive the information on channel information transfer models from the base station. In addition, the terminal may deliver type information of a channel information transfer model used when transferring the wavelet-transformed channel information to the base station. Then, the base station may receive the type information of the channel information transfer model from the terminal, and identify the type of the channel information transfer model. The base station may perform inverse wavelet transform on the channel information by activating the channel information transfer model according to the identified type information of the channel information transfer model.

Alternatively, the base station may transmit a reference signal to the terminal (S2303). Then, the terminal may receive the reference signal from the base station, and generate channel information based on the received reference signal. The terminal may not use wavelet transform. Thereafter, the terminal may compress the channel information with the encoder, and transfer the compressed channel information to the base station (S2304). In this case, the terminal may not transmit wavelet transform use indication information to the base station. Then, the base station may obtain the channel information by receiving the channel information from the terminal and decompressing the channel information.

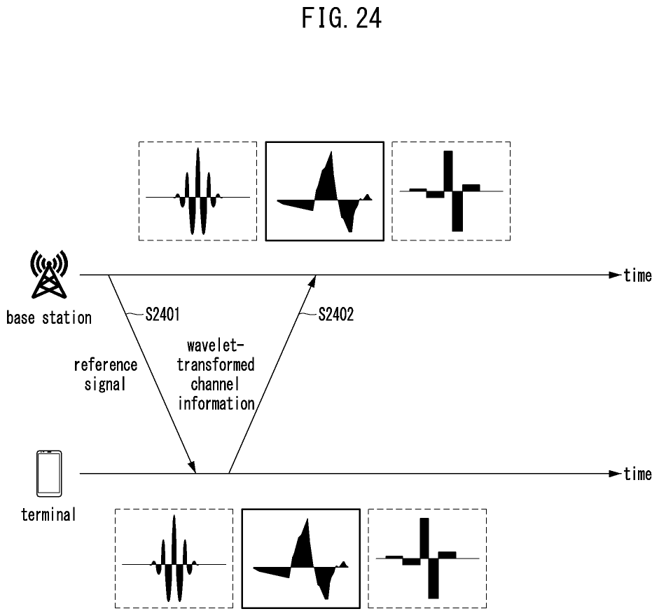

FIG. 24 is a conceptual diagram illustrating a third exemplary embodiment of a channel information transfer method using a neural network in a communication system.

Referring to FIG. 24, the base station may transmit a reference signal to the terminal (S2401). Then, the terminal may receive the reference signal from the base station, and generate channel information based on the received reference signal. The terminal may generate wavelet-transformed channel information using wavelet transform. In this case, the terminal may select and use one waveform type from among the Morlet wavelet waveform, Daubechies wavelet waveform, and biorthogonal wavelet waveform.

Thereafter, the terminal may compress the wavelet-transformed channel information with the encoder to generate compressed wavelet-transformed channel information. Thereafter, the terminal may transfer the compressed wavelet-transformed channel information to the base station (S2402). In this case, the terminal may transmit wavelet transform use indication information and type information of the wavelet waveform together to the base station. Here, the wavelet transform use indication information may be a wavelet transform use indicator. In addition, the type information of the wavelet waveform may be an indicator indicating one of the Morlet wavelet waveform, Daubechies wavelet waveform, and biorthogonal wavelet waveform.

Then, the base station may receive the compressed wavelet-transformed channel information from the terminal. In addition, the base station may receive the wavelet transform use indication information and the type information of the wavelet waveform from the terminal. Accordingly, the base station may identify that wavelet transform is used and obtain the channel information before being wavelet-transformed by performing inverse wavelet transform using the wavelet waveform according to the identified type information of the wavelet waveform.

Meanwhile, the base station may transmit a reference signal to the terminal. Then, the terminal may receive the reference signal from the base station, and generate channel information based on the received reference signal. The terminal may generate wavelet-transformed channel information using wavelet transform. Thereafter, the terminal may transmit channel information for a partial frequency band among the wavelet-transformed channel information to the base station. In this case, the terminal may transmit information on the partial frequency band to the base station together. Then, the base station may receive the wavelet-transformed channel information of the partial frequency band from the terminal. Also, the base station may receive the information on the partial frequency band from the terminal. Accordingly, the base station may perform inverse wavelet transform according to the identified frequency band to obtain inverse-wavelet-transformed channel information.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving a reference signal from a base station;
generating channel information based on the reference signal;
generating wavelet-transformed channel information by applying wavelet transform to the channel information;
generating compressed channel information by compressing the wavelet-transformed channel information; and
transmitting the compressed channel information to the base station.

2. The method according to claim 1, further comprising: receiving a wavelet activation indication from the base station, wherein the terminal generates the wavelet-transformed channel information by applying wavelet transform to the channel information according to the wavelet activation indication.

3. The method according to claim 1, further comprising:
receiving information on a plurality of channel information transfer models including a wavelet transform function from the base station; and
receiving a model activation indication of one channel information transfer model among the plurality of channel information transfer models from the base station,
wherein the terminal generates the wavelet-transformed channel information by activating the one channel information transfer model according to the model activation indication and applying wavelet transform to the channel information.

4. The method according to claim 3, wherein the one channel information transfer model includes a wavelet transformer and an encoder, the wavelet transformer performs wavelet transform on the channel information to generate the wavelet-transformed channel information, and the encoder compresses the wavelet-transformed channel information to generate the compressed channel information.

5. The method according to claim 3, wherein the one channel information transfer model includes a plurality of wavelet transformers and an encoder, the plurality of wavelet transformers generate the wavelet-transformed channel information by performing iterative wavelet transforms on the channel information, and the encoder compresses the wavelet-transformed channel information to generate the compressed channel information.

6. The method according to claim 3, wherein the one channel information transfer model includes a wavelet transformer, a first encoder, and a second encoder, the wavelet transformer generates the wavelet-transformed channel information by performing wavelet transform on the channel information, the first encoder compresses a high frequency band of the wavelet-transformed channel information to generate a part corresponding to a high frequency band of the compressed channel information, and the second encoder compresses a low frequency band of the wavelet-transformed channel information to generate a part corresponding to a low frequency band of the compressed channel information.

7. The method according to claim 3, wherein the one channel information transfer model includes a first wavelet transformer, a second wavelet transformer, a first encoder, and a second encoder, the first wavelet transformer receives the channel information and performs primary wavelet transform on the channel information to generate primary wavelet-transformed channel information, the first encoder compresses the primary wavelet-transformed channel information to generate compressed primary channel information, the second wavelet transformer receives the compressed primary channel information and performs secondary wavelet transform on the compressed primary channel information to generate the wavelet-transformed channel information, and the second encoder compresses the wavelet-transformed channel information to generate the compressed channel information.

8. The method according to claim 1, further comprising: selecting one wavelet waveform from among wavelet waveforms, wherein the terminal performs wavelet transform on the channel information by using the selected one wavelet waveform in generating the wavelet-transformed channel information.

9. The method according to claim 7, wherein the wavelet waveforms include at least one wavelet waveform among a Morlet wavelet waveform, a Daubechies wavelet waveform, or a biorthogonal wavelet waveform.

10. The method according to claim 8, further comprising: transmitting information on the selected one wavelet waveform to the base station.

11. A method of a base station, comprising:
transmitting a reference signal to a terminal;
receiving, from the terminal, compressed channel information obtained through wavelet transform based on the reference signal;
decompressing the compressed channel information to generate wavelet-transformed channel information before being compressed; and
generating channel information before being wavelet-transformed by applying inverse wavelet transform to the wavelet-transformed channel information.

12. The method according to claim 11, further comprising: transmitting a wavelet activation indication to the terminal.

13. The method according to claim 11, further comprising:
transmitting information on a plurality of channel information transfer models including a wavelet transform function to the terminal; and
transmitting a model activation indication of one channel information transfer model among the plurality of channel information transfer models to the terminal,
wherein the base station generates the channel information before being wavelet-transformed by applying inverse wavelet transform to the channel information based on the one channel information transfer model according to the model activation indication.

14. The method according to claim 11, further comprising: receiving information on one wavelet waveform from the terminal, wherein the base station generates the channel information before being wavelet-transformed by applying inverse wavelet transform according to the one wavelet waveform to the wavelet-transformed channel information.

15. A terminal comprising a processor, wherein the processor causes the terminal to:
receive a reference signal from a base station;
generate channel information based on the reference signal;
generate wavelet-transformed channel information by applying wavelet transform to the channel information;
generate compressed channel information by compressing the wavelet-transformed channel information; and
transmit the compressed channel information to the base station.

16. The terminal according to claim 15, wherein the processor further causes the terminal to receive a wavelet activation indication from the base station, wherein the terminal generates the wavelet-transformed channel information by applying wavelet transform to the channel information according to the wavelet activation indication.

17. The terminal according to claim 15, wherein the processor further causes the terminal to:
receive information on a plurality of channel information transfer models including a wavelet transform function from the base station; and
receive a model activation indication of one channel information transfer model among the plurality of channel information transfer models from the base station,
wherein the terminal generates the wavelet-transformed channel information by activating the one channel information transfer model according to the model activation indication and applying wavelet transform to the channel information.

18. The terminal according to claim 15, wherein the processor further causes the terminal to select one wavelet waveform from among wavelet waveforms, wherein the terminal performs wavelet transform on the channel information by using the selected one wavelet waveform in generating the wavelet-transformed channel information.
